(19) United States
(12) Patent Application Publication
(10) Pub. No.: US 2008/0036218 A1
(43) Pub. Date: Feb. 14, 2008

(54) Liftable cover for a computer casing

(75) Inventor: Chien-Fa Liang, Chung-Ho City (TW)

Correspondence Address: TROXELL LAW OFFICE, PLLC, Ste. 1404, 5202 Leesburg Pike, Falls Church, VA, 22041, US

(73) Assignee: Super Micro Computer, Inc.

(21) Appl. No.: 11/501,019

(22) Filed: Aug. 9, 2006

(51) Int. Cl. E05B 3/00

(52) U.S. Cl. 292/336.3

(57) ABSTRACT

A liftable device for a computer casing is composed of a computer casing, an upper plate of which is provided with positioning through-holes; a cover, which is provided with a rectangular hole; the push-in device, which is locked in the rectangular hole, and a sink of which is transfixed with a front pin and a rear pin; a front push plate, a rim at a lower side of which is provided with a projection part, and two sides at a lower end of which are provided with ear parts, with lower ends of the ear parts being provided with push-in ends, and with the ear parts being transfixed with the front pin; a front elastic member; a rear push plate, a locking end of which locks the projection part; and a rear elastic member, which is transfixed with the rear pin, and fixing ends of which are locked in the sink, such that the cover can be quickly removed from the casing, to facilitate an implementation.

### BACKGROUND OF THE INVENTION

(a) Field of the Invention

The present invention relates to a liftable cover for a computer casing, and more particularly to a cover which can be quickly and conveniently lifted up to be removed from the computer casing.

(b) Description of the Prior Art

For a conventional computer casing, when its cover is to be locked on a top of the casing, bolts are always used for screwing the cover to the casing. In particular, when removing the cover from the casing, a screw driver or other tool should be inserted into a gap between the cover and a locking surface of the casing, such that the cover can be pried out of the casing. This conventional technique is provided with the following shortcomings:
(1) A periphery of the cover is easy to be damaged, and a periphery of locking surface of the casing is easy to be damaged.
(2) It is very inconvenient in implementation.

Accordingly, how to quickly and conveniently lift up the cover, such that it can be removed from the casing is an issue to be solved by the present invention.

### SUMMARY OF THE INVENTION

The primary object of present invention is to provide a liftable cover for a computer casing, such that the cover can be quickly removed from the casing to facilitate an implementation.

Another object of the present invention is to provide a liftable device for a computer casing, such that the cover can be connected to the casing without using bolts, and that an implementation will not damage a periphery of the cover or a periphery of locking surface of the casing.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of parts of the present invention.

FIG. 2 shows a perspective view of a push-in device of the present invention.

FIG. 3 shows an exploded view of parts of a push-in device of the present invention.

FIG. 4 shows a schematic view of a motion of push-in device in an open state of the present invention.

FIG. 5 shows another schematic view of a motion of push-in device in an open state of the present invention.

FIG. 6 shows a cross sectional view of a push-in device in a closed state of the present invention.

### DETAILED DESCRIPTION OF THE PREFERRED EMBODIMENTS

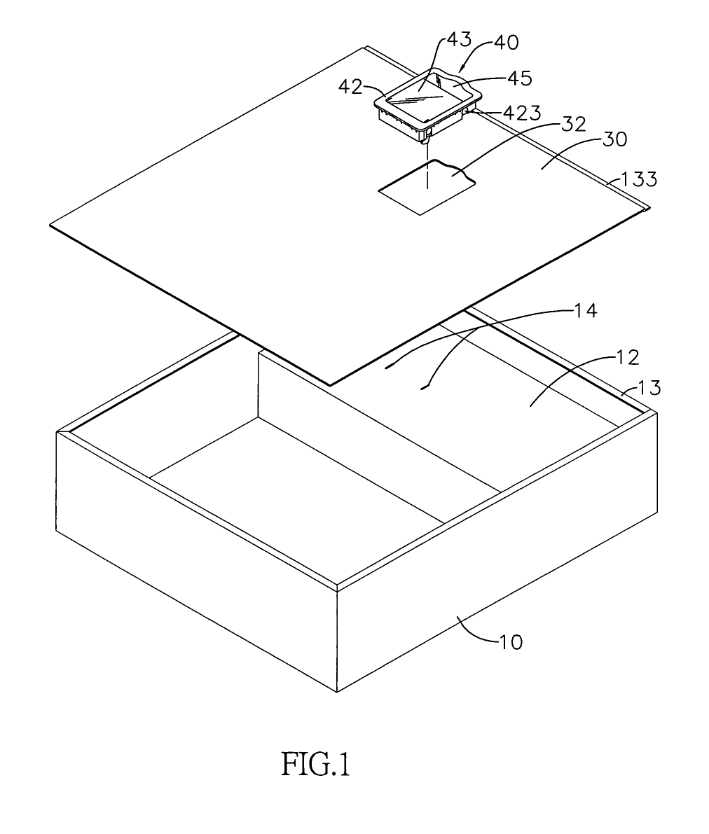

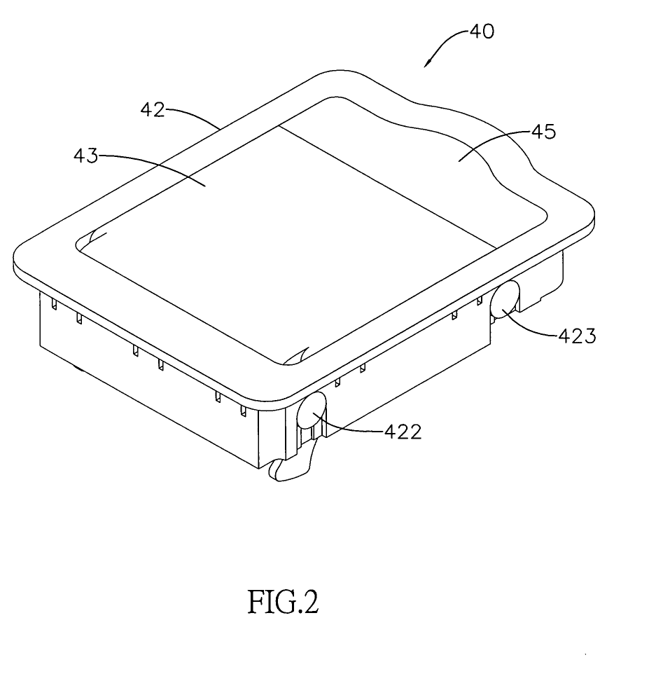

Referring to FIGS. 1 to 3, the present invention is to provide a liftable cover for a computer casing, including a computer casing 10, above which is provided with a fixed upper plate 12 having at least more than one positioning through-hole 14 on a surface thereof; a cover 30, a surface of which is opened with a rectangular hole 32; and a push-in device 40. The push-in device 40 is composed of a rectangular container 42, which is locked and positioned into the rectangular hole 32, and an interior of which is provided with a sink 421 which is transversally transfixed with a front pin 42 and a rear pin 423; a front push plate 43, a rim at a lower rear side of which is extended with a projection part 433, and two sides at a front lower side of which are provided with ear parts 431 respectively, with sides at lower ends of the ear parts 431 being provided with push-in ends 4312, and with through-holes 432 on the ear parts 431 being loosely transfixed with the front pin 422; a front elastic member 44, which is provided with pivot holes 443 to be transfixed with the front pin 422, and fixing ends 441 of which are fixed on wall surfaces of the sink 421, such that the front push plate 43 is provided with elasticity; a rear push plate 45, two sides of which are provided with ear parts 451 respectively, and a lower rim in front of which is provided with a locking end 452 which can lock and position the projection part 433, wherein the ear parts 451 are provided with through-holes 455 which can be transfixed with the rear pin 423; and a rear elastic member 46, which is provided with a pivot hole 463 to be transfixed with the rear pin 423, and a fixing end 461 of which can be locked onto a wall of sink 421.

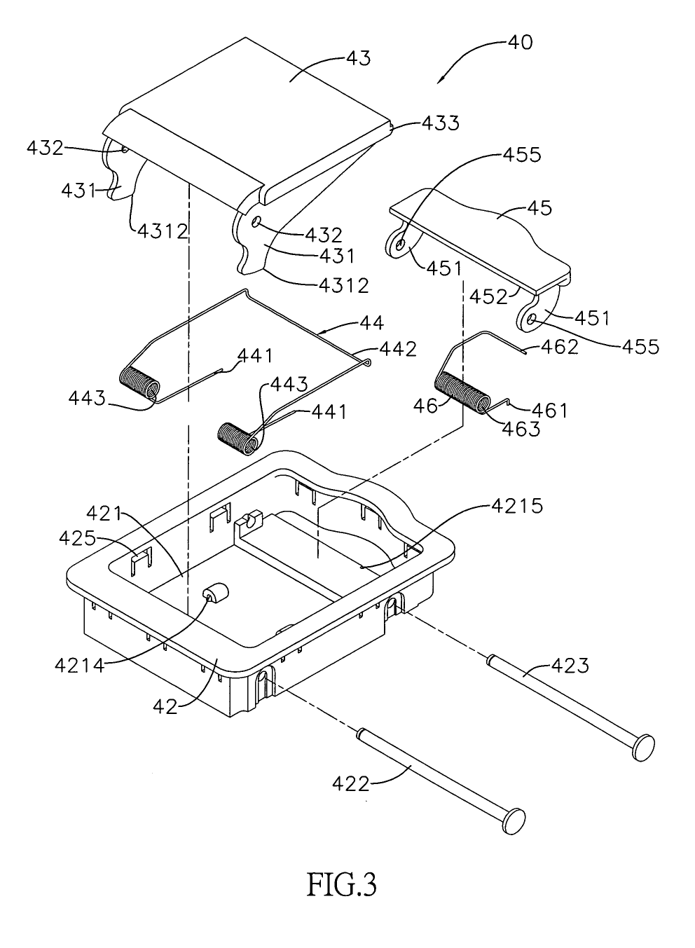

Referring to FIG. 3, walls of the sink 421 of rectangular container 42 are provided with at least more than one locking hole 4214, respectively; whereas the fixing ends 441 of front elastic member 44 are transfixed into the locking holes 4214.

Positioning holes 4215 are located on wall surfaces of the sink 421 to provide for a locking and positioning of the fixing ends 461.

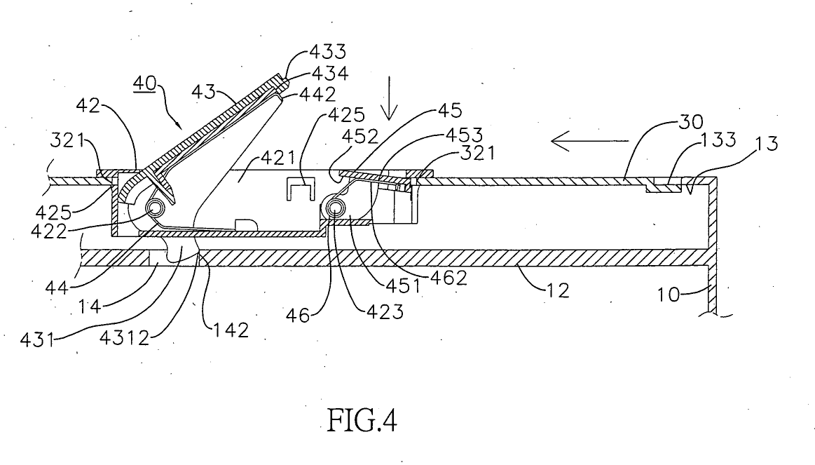

Referring to FIG. 3, a rear side of the front elastic member 44 is provided with a transversal strip 442 which is locked onto an inner wall 434 at a front end of the front push plate 43 (as shown in FIG. 4). In addition, a rear transversal strip 462 of the rear elastic member 46 is abutted on an inner wall 453 of the rear push plate 45.

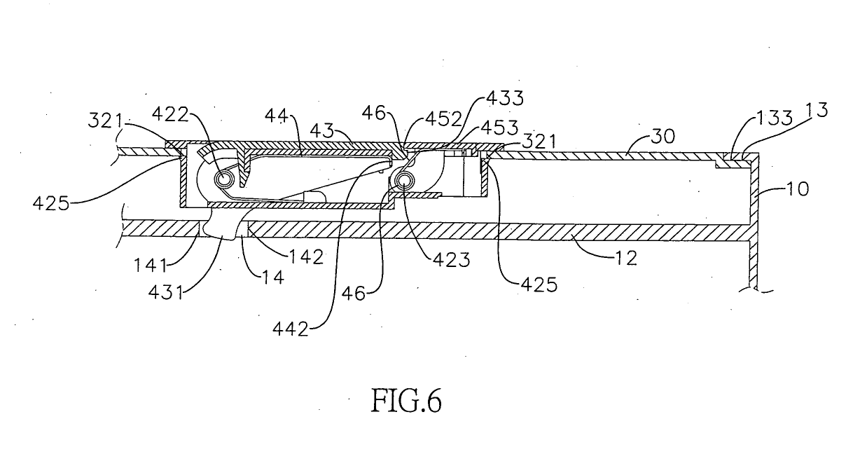

Referring to FIG. 3, any wall of the rectangular container 42 is provided with a flexible projection part 425 which can be abutted on an inner wall 321 at a lower rim of the rectangular hole 32 (as shown in FIG. 6).

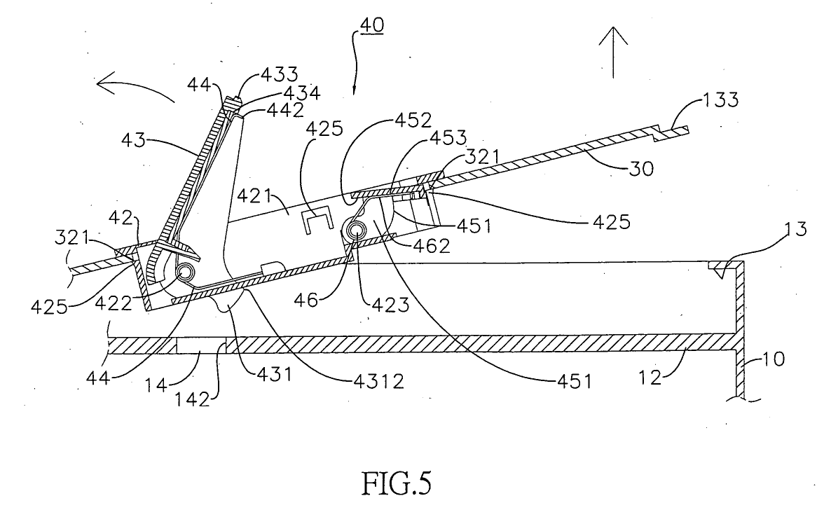

Referring to FIG. 1, a push-in device 40 is latched into a rectangular hole 32 by a rectangular container 42, such that the push-in device 40 can be assembled with a cover 30 to form an integral body. As shown in FIG. 6, a projection part 425 is abutted on an inner wall 321 at a rim of the rectangular hole 32, such that the container 42 of push-in device 40 can be effectively locked and positioned into the rectangular hole 32. A front and a rear elastic member 44, 46 are in a compression state, and a locking end 452 is locking at a projection part 433, such that a front push plate 43 is in a horizontal shape without being raised upward. An ear part 431 is exposed out of a lower side exterior to a sink 421 to move there, and can be projected downward into a through-hole 14, which is provided with a rear hole-wall 142, of an upper plate 12. Referring to FIG. 4, an operator uses fingers to press on a rear push plate 45 which is displaced by a rotation angle using a rear pin 423 as an axis of rotation, such that the rear elastic member 46 can be more tightly formed into a compression state. Therefore, the locking end 452 is raised up by an angle, and is removed from the projection part 433, such that a locking effect of the front push plate 43 from an elastic force disappears, the front elastic member 44 which is originally in the compression state is elastically restored, and the front push plate 43 is reversely rotated by an angle, using a front pin 422 as an axis of rotation. Referring to FIG. 4, a rear push-in end 4312 is abutted on the rear hole-wall 142 to form a pivot of force. When an operator uses fingers to exert an outward pushing force to a left of the front push plate 43 and the cover 30, the rear hole-wall 142 and the rear push-in end 4312 are abutted to form a pivot of force, such that a rear end rim 33 of the cover 30 can be removed from a locking surface 13 of a casing 10. Referring to FIG. 5, the cover 30 can be held by a hand to be successfully taken out of the casing 10 by a tilted angle, to facilitate the operator to perform an operation of assembling and dismantling parts in an interior of the casing 10.

Accordingly, in the present invention, by a design and function of the push-in device 40 between the cover 30 and the casing 10, the cover 30 can be quickly removed out of the casing 10.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A liftable cover for a computer casing, comprising:
a computer casing, above which is provided with a fixed upper plate having at least two positioning through-holes on a surface thereof, and a rear end of which is formed with a locking surface; a cover, a surface of which is opened with a rectangular hole, and a rear end of which is formed with a rear end rim being Protruded downward and horizontally; and a push-in device; said push-in device including a rectangular container, which is locked and positioned into said rectangular hole, an interior provided with a sink being transfixed with a front pin and a rear pin transversely; a front push plate, a rim at a lower rear side provided with a projection part, and two sides at a front lower part respectively provided with ear parts, with sides at lower ends of said ear parts being provided with push-in ends, and with through-holes located on said ear parts being loosely transfixed with said front pin; a front elastic member, which is provided with pivot holes being transfixed with said front pin, and fixing ends fixed on walls of said sink, such that said front push plate is provided with elasticity; a rear push plate, two sides of which are respectively provided with ear parts, with a lower rim in a front of said ear parts being formed with a locking end which can lock and position said projection part, and with said ear parts being provided with through-holes which can be transfixed with said rear pin; and a rear elastic member, which is provided with pivot holes being transfixed with said rear pin, and fixing ends being locked onto walls of said sink, wherein wall surfaces of said sink of rectangular container are respectively provided with at least two locking holes which are transfixed with said fixing ends of said front elastic member, and other positioning holes are located on said walls of said sink to provide for a locking and positioning of said fixing ends,
wherein when an operator uses fingers to exert an outward pushing force to a left of the front push plate and the cover, the rear hole-wall and the rear push-in end are abutted to form a pivot of force, such that a rear end rim of the cover is removed from a locking surface of a casing.
wherein a rear side of said front elastic member is provided with a transversal strip which is locked onto an inner wall at a front end of said front push plate, said transversal strip extending substantially an entire width of said sink, and a rear transversal strip of said rear elastic member is abutted on an inner wall of said rear push plate.

2-3. (canceled)

4. The liftable cover for a computer casing according to claim 1, wherein any wall of said rectangular container is provided with a flexible projection part which is configured to be selectively abutted on an inner wall at a lower rim of said rectangular hole.
